(19) United States
(12) Patent Application Publication
(10) Pub. No.: US 2018/0030621 A1
(43) Pub. Date: Feb. 1, 2018

(54) HIGH STRENGTH POLYAMIDE YARN

(71) Applicant: DSM IP ASSETS B.V., Heerlen (NL)

(72) Inventors: Martinus Joseph Maria KEULERS, Echt (NL); Roman STEPANYAN, Echt (NL); Hao CHEN, Echt (NL)

(21) Appl. No.: 15/552,085

(22) PCT Filed: Feb. 23, 2016
(86) PCT No.: PCT/EP2016/053747

§ 371 Date: Aug. 18, 2017

(30) Foreign Application Priority Data
Feb. 23, 2015 (EP) 15156173.5

(51) Int. Cl. D01F 6/80; B60R 21/235; D02G 3/44

(52) U.S. Cl. CPC D01F 6/80; D02G 3/446; B60R 21/235

(57) ABSTRACT

The invention relates to a Yarn comprising a copolyamide in an amount of at least 90 wt % with respect to the total weight of the yarn, which copolyamide comprises a) at least 95 wt % with respect to the total weight of copolyamide, monomeric units derived from epsilon-caprolactam and b1) cyclic monomeric units derived from a diamine X, and cyclic monomeric units derived from a diacid Y, and/or b2) cyclic monomeric units derived from an amino acid Z, in which the summed amount of monomeric units derived from X,Y and Z is between 0.1 to 4.5 wt % with respect to the total weight of the copolyamide and wherein the yarn has a tensile strength of at least 80 cN/tex as measured according to ASTM D885-04. The invention also relates to a process for preparing the yarn.

This invention relates to high strength polyamide yarns, as well as a process for preparing these yarns.

High strength polyamide yarns are known and are for example applied in tyre cords, air bags. The yarns may be prepared from for example polyamide-6 or polyamide-66. There is a continuous demand for providing yarns with higher strengths, for which tenacity values is a measure to define strength. Fiber tenacity can be measured, e.g. by a STATIMAT 4U automatic tensile testing machine, according to ASTM D885-04. By having higher strength yarn, the total weight of the end product can be reduced in order to keep the same product strength, which is beneficial from an environmental perspective. For example, in the automotive industry, more and more air bags are being employed, which require high strength yarns. By increasing the strength of the yarn, the total weight of air bags can be reduced, which results in lower CO₂-emissions for the car. Alternatively, other applications become feasible for high strength yarns, in which strength is a key factor, such as ropes, tire cords, etc.

Many attempts have been made to increase strength of a yarn, which includes for example the preparation of yarns from thin filaments and utilizing special cooling equipment and steam treatment, as disclosed in EP2264235. EP2264235 discloses yarn for air bags comprising polyamide, in which the single fiber fineness is 1 to 2 dtex and in which strengths are reached of around 8.5 cN/dtex.

Another example in the prior art, disclosed in U.S. Pat. No. 4,701,377, allows preparing fibers stronger than 12 g/d (ca 10.5 cN/dtex) following a special spinning and drawing procedure, including superheated steam treatment.

The main disadvantage about the methods disclosed, however, is that special non-standard equipment is necessary to reach superior properties, which renders all these methods economically less attractive. Commercially available polyamide 6 and polyamide 66 yarns, produced with economically feasible processes, feature tenacity of no more than about 8.5 cN/dtex.

It is an object of the present invention to provide yarns which exhibit higher strengths and may be produced in an economically feasible way.

This object has been met by a yarn comprising a copolyamide in an amount of at least 90 wt % with respect to the total weight of the yarn, which copolyamide comprises

a) at least 95 wt % with respect to the total weight of copolyamide, monomeric units derived from epsilon-caprolactam and

b1) cyclic monomeric units derived from a diamine X, and cyclic monomeric units derived from a diacid Y, and/or

b2) cyclic monomeric units derived from an amino acid Z,

in which the summed amount of monomeric units derived from X,Y and Z is between 0.1 to 4.5 wt % with respect to the total weight of the copolyamide and wherein the yarn has a tensile strength of at least 80 cN/tex as measured according to ASTM D885-04.
Wt % is understood to be percentage by weight.

Essentially equal molar amounts is herein understood that the molar ratio of monomeric units derived from X: monomeric units derived from Y is between 0.8 and 1.2, preferably between 0.9 and 1.1 and even more preferred between 0.95 and 1.05.

Preferably, the monomeric units derived from X and Y are present in essentially equal molar amounts.

The inventors have surprisingly found that a yarn according to the invention exhibits higher strengths as compared to a yarn which are made from a homopolyamide. Another advantage is that the yarns can be prepared by a simple process.

With homopolyamide herein is understood a polyamide which consists essentially of monomeric units derived from epsilon-caprolactam. This polyamide is also referred to as PA-6.

A copolyamide herein is understood to be a copolyamide which comprises besides a majority of monomeric units derived from epsilon-caprolactam, monomeric units derived from a diamine and a diacid and/or a further aminoacid. Such copolyamide is also denoted as PA-6/XY, in which X refers to a diamine and Y refers to a diacid or PA-6/Z, in which Z refers to an aminoacid or PA-6/XY/Z. A copolyamide is to be distinguished from a blend, which is for example denoted as PA-6/PA-XY or PA-6/PA-Z. A blend is prepared by mixing two polyamides, whereas a copolyamide is prepared by mixing monomers which subsequently polymerize to a copolyamide.

With monomers is herein understood a molecule that when chemically bound to other monomers forms a polymer. For polyamides, potential monomers include for example aminoacids, diamines and diacids, as well as their salts.

With monomeric unit is herein understood a unit derived from a monomer as it is present in a polymer.
Suitable cyclic monomeric units derived from diamines X include for example:

C6 to C20 aromatic diamine, such as m- or p-phenylenediamine,

C7 to C20 arylaliphatic diamine, such as 4,4′-diaminodiphenylpropane, meta-xylylene diamine (MXD), para-xylylene diamine (PXD),

C6 to C20 cyclic aliphatic diamine, such as 1,4-diaminocyclohexane, 4-aminomethylcyclohexylamine, 5-Amino-1,3,3-trimethylcyclohexanemethylamine (also referred to as isophorone diamine, IPD), 3,3′-dimethyl-4,4′-diamino-dicyclohexylmethane, bis-(p-aminocyclohexane)methane, 2,2-di(4-aminocyclohexyl)-propane, 3,6-bis(aminomethyl)norbornane,

including stereo isomers and/or cis trans isomers thereof.

Preferably, the cyclic monomeric units derived from diamines X are monomeric units derived from C6 to C20 cyclic aliphatic diamines as listed above, as these exhibit a higher reactivity and are easier built in a copolyamide.

Suitable cyclic monomeric units derived from dicarboxylic acids Y include for example:

C8 to C20 aromatic dicarboxylic acid, such as naphthalene-2,6-dicarboxylic acid, naphthalene-1,4-dicarboxylic acid, isophthalic acid (I), terephthalic acid (T),

C8 to C20 arylaliphatic dicarboxylic acid, such as o-, m- or p-phenylenediacetic acid, 4-methylisophthalic acid, 4-tert-butylisophthalic acid

C6 to C20 cyclic aliphatic dicarboxylic acid, including hydrogenated naphthalene dicarboxylic acids, hydrogenated 2,6-naphthalene dicarboxylic acid, as well as 1,4-cyclohexane dicarboxylic acid, 1,3-cyclohexane dicarboxylic acid,

including stereo isomers and/or cis trans isomers thereof. Preferably, the cyclic monomeric units derived from dicarboxylic acids are derived from isophthalic acid as this is easily dissolved in water and can be easier dosed. Another preferred cyclic monomeric unit is derived from terephthalic acid as this is readily available.

Hydrogenated is herein understood that all aromatic rings are fully hydrogenated into a cyclic aliphatic unit.

Suitable cyclic monomeric units derived from amino acids Z include monomeric units derived from 4-aminomethylcyclohexylcarboxylic acid, 4-aminocyclohexaneacetic acid, including cis and trans isomers thereof.

Epsilon-caprolactam, although being cyclic as a monomer, is not considered a cyclic monomeric unit as it does not contain a cyclic structure upon presence as a monomeric unit in a polyamide.

Preferably, the cyclic monomeric units derived from X and Y and/or Z, have at least one cyclic structure containing 5 or 6 carbon atoms, such as a cyclo pentane structure, phenyl structure or cyclo hexane structure, which may for example be derived from 1,3 diaminocyclopentane, isophorone diamine, terephthalic acid, isophthalic acid.

Preferably, the yarn comprises a copolyamide in an amount of at least 95 wt % with respect to the total weight of the yarn, which copolyamide comprises

a) at least 95 wt % with respect to the total weight of copolyamide, monomeric units derived from epsilon-caprolactam and

b1) cyclic monomeric units derived from a diamine X, and cyclic monomeric units derived from a diacid Y,

in which the summed amount of monomeric units derived from X and Y is between 0.5 to 4.0 wt % by weight with respect to the total weight of the copolyamide. Preferably, monomeric units derived from X and Y are present in essentially equal molar amounts.

More preferred is a yarn, comprising a copolyamide in an amount of at least 95 wt % with respect to the total weight of the yarn, which copolyamide comprises

A at least 95 wt % with respect to the total weight of copolyamide, monomeric units derived from epsilon-caprolactam and

b1) cyclic monomeric units derived from a diamine X being isophorone diamine, and cyclic monomeric units derived from a diacid Y chosen from isophthalic acid and terephthalic acid,

in which the summed amount of monomeric units derived from X and Y is between 0.5 to 4.0 wt % by weight with respect to the total weight of the copolyamide. Most preferred, the monomeric units derived from X and Y are present in essentially equal molar amounts.

The yarn comprises a copolyamide in an amount of at least 90 wt % with respect to the total weight of the yarn, preferably at least 95 wt % and most preferred at least 97 wt %. The yarn may comprise other additives which may be for example stabilizers as well as pigments.

In many applications, including for example air bag fabrics, high tenacity, low titer, low hot air shrinkage (HAS) yarns are desired. The yarn according to the invention preferably has a titer of between 200 dtex and 700 dtex, more preferably between 300 dtex and 500 dtex and most preferred between 300 dtex and 400 dtex. A lower titer of the yarns allows weight savings, but also allows for example more compact, better foldable fabrics prepared from the yarn, such as for example in applications of air bags.

To ensure the product strength in combination with a thin fabric, low titer yarns are preferably used in combination with a high tenacity. The usage of 450 dtex to 500 dtex yarns typically requires a yarn with a tenacity of at least 80 cN/tex.

The yarn according to the invention exhibits a tensile strength of at least 80 cN/tex as measured according to ASTM D885-04, preferably the yarn has a tensile strength of at least 85 cN/tex and more preferably at least 90 cN/tex. Yarns with a tensile strength of at least 80 cN/tex are also referred to herein as technical yarns, in contrast to textile yarns. Textile yarns usually have lower tensile strength and are usually not suitable for applications in which technical yarns are employed.

Even more preferred, the yarn has a titer of between 300 dtex and 400 dtex and a tenacity of at least 85 cN/tex, most preferred the yarn has a titer of between 300 dtex and 400 dtex and a tenacity of at least 90 cN/tex, as this allows thinner fabrics with higher strength.

In another embodiment, the yarn according to the invention has a hot air shrinkage of at most 10.0%, preferably at most 8.0%, more preferably at most 7.0% and most preferred at most 5.0%, as this allows for higher dimensional stability. HAS is measured at 177° C. after 2 min, as explained below. HAS values as low as 1.0% may be attained.

In yet another embodiment, the yarn according to the invention has a HAS of at most 10.0%, preferably at most 7.0% and a tenacity of at least 80 cN/tex, preferably at least 85 cN/tex, and a titer of between 200 dtex and 700 dtex, preferably between 300 dtex and 500 dtex.

### TEST METHODS

Conditioning: prior to all the measurements, described below, bobbins containing the yarns, were conditioned for at least 12 hours in a 55% relative humidity 23° C. atmosphere.
Tensile strength of fibers, also known as tenacity, is measured according to ASTM D885-04 and given in cN/dtex or cN/tex. The measurement was performed using STATIMAT 4U automatic tensile testing machine.
Fiber titer, also referred to as linear density, measured in dtex, is defined as weight in grams of 10000 meters of yarn. The titer can be measured by weighing a piece of yarn of a known length, usually 20 meters, on a balance with accuracy of 0.001 g and then recalculating the weight of 10000 meters of yarn. In practice, the titer measurement is automated and performed by STATIMAT 4U as well.
Hot air shrinkage (HAS) is measured according to ASTM D4974-04 at 177° C. for 2 minutes using Testrite shrinkage measurement instrument under a load of 5 mN/tex.

### PROCESS FOR PREPARING YARNS

A process for preparing a yarn according to the present invention generally comprises the following steps and is further referred to as process A:

Providing a composition comprising a copolyamide to an extruder and melting it, optionally mixing with additives, such as stabilizer or pigment, to obtain a molten composition;

The molten composition is extruded through a spinneret to form filaments, which are subsequently stretched, cooled and combined to form at least one yarn;

The at least one yarn is subsequently subjected to a drawing process at a temperature of between 25° C. and 220° C. to a draw ratio of between 4 and 6. Preferably the drawing is carried out at a temperature between 50° C. and 170° C. The drawing may be performed, e.g., by means of pairs of heated draw rolls, heated hot air ovens, etc.

Optionally, after drawing the yarn is subjected to a relaxation and/or a heat set step;

The at least one yarn is wound up. Preferably, the at least one yarn is wound up on a bobbin.

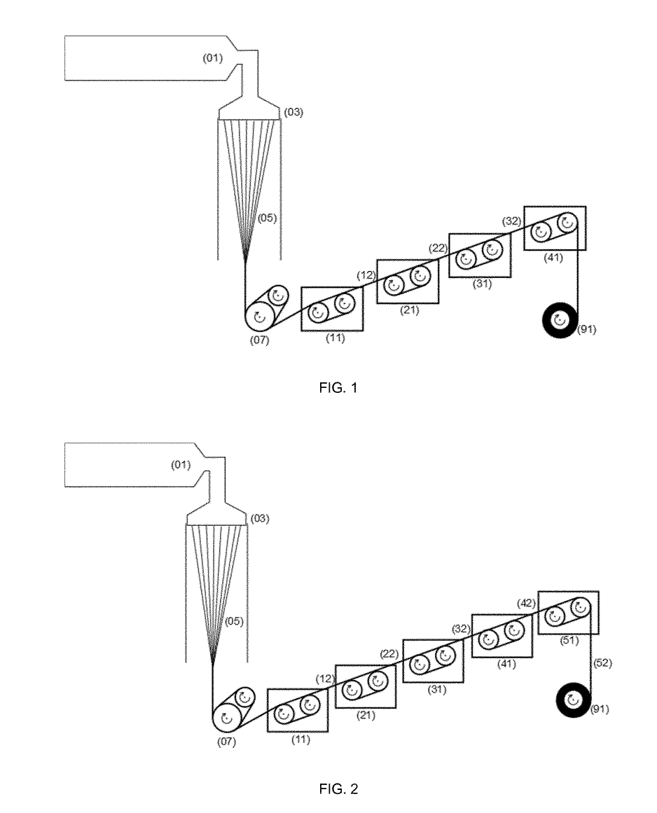

List of numbers for FIG. 1 and FIG. 2:

(01) Extruder

(03) Spinneret

(05) Filaments

(07) Take up rolls

(11) First rolls pair

(21) Second rolls pair

(31) Third rolls pair

(41) Fourth rolls pair

(51) Fifth rolls pair

(91) Reel device

(12) First drawing step

(22) Second drawing step

(32) First relaxation step

(42) Second relaxation step

(52) Third relaxation step

An example of the apparatus to perform the process A is illustrated in Error! Reference source not found.

The composition is molten and, if necessary, mixed with additives such as for example stabilizers, pigments, in an extruder (01) and further extruded through a spinneret (03) to form filaments. The filaments (05) are cooled, drawn and combined to at least one yarn between the spinneret (03) and take up rolls (07). Further a two stage drawing of the yarn is performed. First, the yarn is heated up by a pair of rolls (11) to a temperature between 50° C. and 80° C. and drawn 2 to 3 times in air gap (12) between pairs of rolls (11) and (21). Then, the yarn is heated up by a pair of rolls (21) to a temperature between 120° C. and 200° C. and drawn 1.35 to 3 times in air gap (22), between pairs of rolls (21) and (31), resulting in a draw ratio between 4 and 6. The drawing steps are followed by heat setting and relaxation: the yarn is heated up to the temperatures of 170° C. to 200° C. by a pair of rolls (31) and relaxed by 0% to 10% in the air gap (32) between the pairs of rolls (31) and (41). Finally, the yarn is wound up on a bobbin by a reel device (91).

The yarn according to the invention is preferably made by a process, hereafter referred to as process B, which comprises the following steps:

Providing a composition comprising a copolyamide to an extruder and melting it, optionally mixing with additives, such as stabilizer or pigment, to obtain a molten composition;

The molten composition is extruded through a spinneret to form filaments, which are subsequently stretched, cooled and combined to form at least one yarn;

The at least one yarn is subsequently subjected to a drawing process at a temperature between 25° C. and 220° C. to a draw ratio of between 4 and 6. Preferably the drawing is carried out at a temperature between 50° C. and 170° C. The drawing may be performed, e.g., by means of pairs of heated draw rolls, heated hot air ovens, etc.

After drawing, the yarn is relaxed by from 4% to 10% in at least three stages while being kept in a temperature range of 205° C. to 215° C.

The at least one yarn is wound up. Preferably, the at least one yarn is wound up on a bobbin.

Preferably, the temperature during relaxation is higher than the highest temperature during drawing. This has the advantage that the relaxation is more effective. More preferably, the temperature during relaxation is increased in each subsequent stage. This has the advantage that sufficient yarn tension is maintained between the relaxation rolls, which avoids breaking of the yarn.

The advantage of process B is that it yields yarns with a lower hot air shrinkage as compared to process A.

An example of the apparatus to perform process B is illustrated in Error! Reference source not found. The difference between FIG. 2 and the process described in Error! Reference source not found. is that five heated roll pairs (11), (21), (31), (41), (51) are employed, instead of four. The extrusion (01), the spinneret (03), the air gap (05), the take up rolls (07) as well as the first two roll pairs (11), (21) conditions can be chosen in the same way as in the process A, as illustrated in Error! Reference source not found. To achieve low HAS values, rolls (31),(41) and (51) have to be set to a temperature of between 205° C. and 215° C., the yarn being relaxed by from 4% to 10% in the at least three stages (32), (42), (52). The yarn is subsequently wound up on a reel device (91).

Applications for the yarn according to the invention include air bag fabric such as air bags for driver, passenger, knee, curtain airbags. Other applications include ropes, tire cords.

### EXAMPLE 1 (EX 1)

A yarn consisting of 72 filaments was prepared from a copolyamide PA6/IPDT according to process A. The copolyamide was synthesized from a mixture of epsilon-caprolactam, isophorondiamine (IPD), and terephthalic acid (T). The monomeric unit derived from IPD was 0.5 wt % with respect to the copolyamide and the monomeric unit derived from T was 0.5 wt % with respect to the copolyamide. The remainder of the copolyamide were monomeric units derived from epsilon-caprolactam, thus 99 wt %. The synthesized copolyamide had a relative viscosity of 3.2 as measured in 90% formic acid HCOOH.

Using the apparatus as illustrated in Error! Reference source not found., operated at the process conditions specified in the “Ex 1” column in Table 1. After take up, the yarn was drawn in a two-step process to a draw ratio of 5.0. After hot drawing, relaxation of in total 6% has been applied between the 3^{rd} and the 4^{th} rolls pair and between the 4^{th} rolls pair and the reeling device.

The yarn thus obtained had a tenacity of 93cN/tex, elongation at break of 20%, titer of 354dtex, and hot air shrinkage, as measured at 177° C. 2 min, of 8.9%.

### EXAMPLE 2 (EX 2)

The same copolyamide has been used as in the Example 1 and the yarn was prepared according to process A.

Using the apparatus as illustrated in Error! Reference source not found., operated at the process conditions specified in the “Ex 2” column in Table 1. After take up, the yarn was drawn in a two-step process to a draw ratio of 5.0. After hot drawing, relaxation of in total 4% has been applied between the 3^{rd} and the 4^{th} rolls pair and between the 4^{th} rolls pair and the reeling device.

The yarn thus obtained had a tenacity of 94cN/tex, elongation at break of 20%, titer of 473dtex, and hot air shrinkage, as measured at 177° C. 2 min, of 9.0%.

### EXAMPLE 3 (EX 3)

The same copolyamide has been used as in the Example 1. The yarn was prepared according to process B.

Using the apparatus as illustrated in Error! Reference source not found., operated at the process conditions specified in the “Ex 3” column in Table 1. After take up, the yarn was drawn in a two-step process to a draw ratio of 4.9. After hot drawing, three-step relaxation process of in total 10% has been applied between the 3^{rd} and the 4^{th} rolls pair, between the 4^{rd} and the 5^{th} rolls pair and between the 5^{th} rolls pair and the reeling device.

The yarn thus obtained had a tenacity of 90cN/tex, elongation at break of 22%, titer of 356dtex, and hot air shrinkage, as measured at 177° C. 2 min, of 6.1%.

### Comparative Example A (Comp A)

A yarn consisting of 72 filaments was prepared from a homopolyamide PA6 according to process A. The homopolymer was synthesized from epsilon-caprolactam contributing 100 wt % of the monomers. The synthesized PA6 had a relative viscosity of 3.2 as measured in 90% formic acid HCOOH.

Using the apparatus as illustrated in Error! Reference source not found., operated at the process conditions specified in the “Comp A” column in Table 1. After take up, the yarn was drawn in a two-step draw process to a draw ratio of 4.5. Higher draw ratios were not achievable as they led to spinline breakages.

After hot drawing, relaxation of in total 6% has been applied between the 3^{rd} and the 4^{th} rolls pair and between the 4^{th} rolls pair and the reeling device.

The yarn thus obtained had a tenacity of 85cN/tex, elongation at break of 18%, titer of 356dtex, and hot air shrinkage, as measured at 177° C. 2 min, of 8.8%.

### Comparative Example B (Comp B)

The same homopolyamide PA6 has been used as in the Comparative Example A and the yarn was prepared according to process B.

Using the apparatus as illustrated in Error! Reference source not found., operated at the process conditions specified in the “Comp B” column in Table 1. After take up, the yarn was drawn in a two-step process to a draw ratio of 4.3. After hot drawing, three-step relaxation process of in total 10% has been applied between the 3^{rd} and the 4^{th} rolls pair, between the 4^{rd} and the 5^{th} rolls pair and between the 5^{th} rolls pair and the reeling device.

The yarn thus obtained had a tenacity of 81cNitex, elongation at break of 25%, titer of 469dtex, and hot air shrinkage, as measured at 177° C. 2 min, of 4.6%.

TABLE 1

| Example number | | | | |
|---|---|---|---|---|
| Ex 1 | Ex2 | Ex3 | Comp A | Comp B |

| Material | |
|---|---|
| Copolyamide PA6/IPDT | Homopolymer PA6 |

PROCESS CONDITIONS:

| Temperature at the | | ° C. | 290 | 290 | 290 | 290 | 290 |
|---|---|---|---|---|---|---|---|
| spinneret | | | | | | | |
| Take up rolls speed | | m/min | 681 | 679 | 689 | 758 | 793 |
| 1^{st} rolls | Speed | m/min | 702 | 705 | 711 | 780 | 817 |
| pair | Temperature | ° C. | 70 | 70 | 70 | 70 | 70 |
| 2^{nd} rolls | Speed | m/min | 1800 | 1800 | 1800 | 2000 | 2368 |
| pair | Temperature | ° C. | 155 | 155 | 155 | 155 | 155 |
| 3^{rd} rolls | Speed | m/min | 3409 | 3409 | 3409 | 3409 | 3409 |
| pair | Temperature | ° C. | 200 | 200 | 210 | 200 | 210 |
| 4^{th} rolls | Speed | m/min | 3272 | 3272 | 3272 | 3272 | 3272 |
| pair | Temperature | ° C. | 170 | 170 | 215 | 170 | 215 |
| 5^{th} rolls | Speed | m/min | | | 3150 | | 3150 |
| pair | Temperature | ° C. | | | 215 | | 215 |

| | | | | | | |
|---|---|---|---|---|---|---|
| Reel device speed | m/min | 3201 | 3194 | 3098 | 3108 | 3110 |
| Drawing ratio | — | 5.0 | 5.0 | 4.9 | 4.5 | 4.3 |

TEST RESULTS:

| | | | | | | |
|---|---|---|---|---|---|---|
| Titer | dtex | 354 | 473 | 356 | 356 | 469 |
| Number of filaments | — | 72 | 140 | 72 | 72 | 140 |
| Tenacity | cN/tex | 93 | 94 | 90 | 85 | 81 |
| Elongation at break | % | 20 | 20 | 22 | 18 | 25 |
| HAS 177° C. 2 min | % | 8.9 | 9.0 | 6.1 | 8.8 | 4.6 |

The examples as shown in Table 1 show the advantages of the yarn according to the invention as compared to a yarn prepared from a homopolyamide.

As Example 1 shows, the yarn according to the invention could be drawn to a draw ratio of 5.0 and reached tenacity of 93cNitex. Similar properties could also be reached with yarn with a higher titer as well, as shown in the Example 2.

As Comparative example A shows, a homopolyamide of the same relative viscosity being spun at very similar conditions could be drawn only 4.5 times resulting in a yarn with tenacity of 85cN/tex, which is approximately 10% lower than the yarn made with the copolyamide from the Example 1.

Example 3 illustrates that if a process B is employed yarns with a tenacity of 90cN/tex and low hot air shrinkage could be obtained by employing the copolyamide.

If a homopolyamide is used in a process B as shown in the Comparative example B, then the yarn tenacity reached only 81cN/tex, which is approximately 10% lower than the yarn obtained from the copolyamide in Example 3.

1. Yarn comprising a copolyamide in an amount of at least 90 wt % with respect to the total weight of the yarn, which copolyamide comprises
a) at least 95 wt % with respect to the total weight of copolyamide, monomeric units derived from epsilon-caprolactam and
b1) cyclic monomeric units derived from a diamine X, and cyclic monomeric units derived from a diacid Y, and/or
b2) cyclic monomeric units derived from an amino acid Z,
in which the summed amount of monomeric units derived from X,Y and Z is between 0.1 to 4.5 wt % with respect to the total weight of the copolyamide and wherein the yarn has a tensile strength of at least 80 cN/tex as measured according to ASTM D885-04.

2. Yarn according to claim 1, comprising at least 95 wt % of the copolyamide with respect to the total weight of the yarn.

3. Yarn according to claim 1, in which X and Y are present in essentially equal molar amounts.

4. Yarn according to claim 1, in which the yarn has a tensile strength of at least 85 cN/tex.

5. Yarn according to claim 1, in which the summed amount of monomeric units derived from X, Y and Z is between 0.5 to 4.0 wt % with respect to the total weight of the copolyamide.

6. Yarn according to claim 1, in which the diamine X is isophorone diamine and the diacid Y is chosen from the group of isophthalic acid and terephthalic acid.

7. Yarn according to claim 1, in which the hot air shrinkage is between 1.0 to 8.0% as measured according to ASTM D4974-04 at 177° C. for 2 minutes.

8. Yarn according to claim 1, in which the yarn has a titer of between 200 to 700 dtex.

9. Yarn according to claim 1, in which the yarn has a titer of between 300 dtex and 500 dtex and a tenacity of at least 85 cN/tex.

10. Yarn according to claim 1, in which the yarn has a HAS of at most 8.0% and a tenacity of at least 85 cN/tex, and a titer of between 300 dtex and 400 dtex.

11. Process for preparing a yarn according to claim 1, in which the process comprises the following steps:
Providing a composition comprising a copolyamide to an extruder and melting it, optionally mixing with additives, such as stabilizer or pigment, to obtain a molten composition;
The molten composition is extruded through a spinneret to form filaments, which are subsequently stretched, cooled and combined to form at least one yarn;
The at least one yarn is subsequently subjected to a drawing process at a temperature between 25° C. and 220° C. to a draw ratio of between 4 and 6;
After drawing, the yarn is relaxed by from 4% to 10% in at least three stages while being kept in a temperature range of 205° C. to 215° C.;
The at least one yarn is wound up.

12. Process according to claim 11, in which the drawing process is carried out at a temperature between 50° C. and 170° C.

13. Air bag fabric, comprising a yarn according to claim 1.
